(19) United States
(12) Patent Application Publication
(10) Pub. No.: US 2026/0110835 A1
(43) Pub. Date: Apr. 23, 2026

(54) MOTOR VEHICLE DISPLAY DEVICE FOR AN INTERIOR OF A MOTOR VEHICLE, MOTOR VEHICLE COMPRISING AT LEAST ONE MOTOR VEHICLE DISPLAY DEVICE, AND METHOD FOR OPERATING A MOTOR VEHICLE DISPLAY DEVICE

(71) Applicant: AUDI AG, Ingolstadt (DE)

(72) Inventors: Jacques Hélot, Ingolstadt (DE); Daniel Bopp, Hadamar (DE); Ulrich Müller, Ingolstadt (DE)

(73) Assignee: AUDI AG, Ingolstadt (DE)

(21) Appl. No.: 19/367,254

(22) Filed: Oct. 23, 2025

(30) Foreign Application Priority Data
Oct. 23, 2024 (DE) 10 2024 130 933.4

(51) Int. Cl. F21V 8/00

(52) U.S. Cl. CPC G02B 6/0088

(57) ABSTRACT

A motor vehicle display device for an interior of a motor vehicle comprising a flat transparent display having a display area, a switchable layer being attached to a surface of the flat transparent display opposite to the display area, transmittance of the switchable layer being changeable. On a side of the switchable layer, a planar light guide is arranged, spaced apart from the switchable layer by a cavity. The planar light guide is configured to emit light from at least one light source via an exit surface along a direction of the flat transparent display. The planar light guide comprises at least one connection for the at least one light source, and the at least one connection is attached to a circumference of the planar light guide.

### CROSS REFERENCE TO RELATED APPLICATIONS

This application is a based upon and claims the priority benefit of German Application No. 102024 130 933.4 filed on October 23, 2024, the entire contents of which are incorporated by reference herein.

### BACKGROUND

### 1. Field

The invention relates to a motor vehicle display device for an interior of a motor vehicle, a motor vehicle comprising at least one motor vehicle display device, and a method for operating a motor vehicle display device.

### 2. Description of the Related Art

In order to be able to reproduce at least one item of information in a motor vehicle, in particular an interior of the motor vehicle, hereinafter referred to as a vehicle interior, it can be provided that at least one motor vehicle display device (hereinafter also referred to only as a display device) is provided in the motor vehicle. Various display devices with different modes of operation are known from the prior art.

An example of a display device for a means of transport is given in document DE 102022205083 A1, wherein this display device has a display panel and a backlight. The backlight is provided by a reflector having a plurality of cavities designed to be reflective and light sources arranged in each of the cavities. The disadvantage of this device is that it is not possible to see through the display device.

This disadvantage can be eliminated by a transparent display as a display device, as it is known from the prior art and is used, for example, for augmented reality glasses and/or head-up displays. A transparent display is characterized in that at least one item of information can be reproduced on its surface, but it is also possible to see through the transparent display. As an example, document DE 3120601 A1 is cited, which discloses a transparent display as a display device for a motor vehicle, wherein the structure and/or mode of operation of the transparent display is not restricted to that disclosed in the cited document.

A disadvantage of transparent displays, in particular transparent displays which are based on LED (light-emitting diode) or OLED (organic LED) and are known from the prior art, is that no dark and/or black pixels can be generated, such pixels being generated, for example, by the absence of light in non-transparent displays (i.e. dark or black pixels in non-transparent displays can be generated, for example, in that no light is generated for the pixel), since in the transparent display light elements are shown on a transparent background in particular. Dark and/or black pixels are to be understood as pixels that do not emit light within the limits of the technical possibilities, for example, in order to be able to display black elements on the display. The problem of generating dark and/or black pixels can be solved, for example, by a darkening layer behind the transparent display. This, however, will reduce a transparency of the display, that is, a transmittance, which describes the ratio of the light penetrating the display and/or the display device to the incident light.

### SUMMARY

One object of the invention, according to an aspect of the present invention, is to provide a display device that is as transparent as possible, but can still depict black and/or dark pixels.

The objects of the present invention are achieved by the subject matter of the independent patent claims. Advantageous developments of the invention are described by the dependent claims, the following description, and the figures.

As a solution, the invention, according to an aspect of the present invention, comprises a motor vehicle display device, hereinafter also referred to as a display device, for the interior of a motor vehicle (vehicle interior). The display device comprises a planar transparent display (in the following, the transparent display is also referred to as a display) having a display area. The display area is configured in particular for the reproduction of contents, which are to be displayed by means of the display device. This means, for example, that contents to be displayed for at least one occupant of the vehicle on the display device are displayed on the display area of the display device and/or are visible on the display area of the display device for the at least one occupant of the motor vehicle. This means, for example, that the display area is an area of the display device facing toward the at least one occupant. Planar means in the present case that in at least one preferred direction, preferably in the direction perpendicular to the display area, an extension is less than in the directions perpendicular to the preferred direction. In particular, the extension in the preferred direction is substantially less, for example, at most 10%, in particular at most 1%, preferably at most 0.1%, of the extension in the direction perpendicular to the preferred direction.

On an area of the display opposite to the display area, thus in particular on a rear side of the display area and/or an area of the transparent display which has an inverse orientation to the display area, a switchable layer is applied, the transmittance of which can be changed and/or regulated. The switchable layer is known from the prior art, wherein the switchable layer can be a glass and/or a film, which can also be known under the designations intelligent glass and/or switchable glass as glass. In particular, the switchable layer is a, preferably tintable, layer, for example a film and/or a glass, the light transparency and/or transmittance of which can be changed, for example, by applying an electrical voltage and/or by changing light conditions and/or by heating. By way of the switchable layer, dark and/or black pixels can be implemented on the display by reducing the transmittance of the switchable layer, due to which in particular a darker and/or black background behind the transparent display can arise and/or can be adjusted.

On the side of the switchable layer, a planar light guide (hereinafter also referred to as light guide) is arranged spaced apart by a cavity from the switchable layer. The cavity can have a thickness of between 1 cm and 30 cm, in particular between 5 cm and 20 cm. This means that the distance between the switchable layer and the light guide can be at most 30 cm, in particular at most 20 cm and/or is at least 1 cm, in particular at least 2 cm, preferably at least 5 cm. In particular, the cavity is filled with air and/or a gas. This means in particular that, due to the cavity, the planar light guide does not touch and/or contact the display and/or the switchable layer and/or only does so in sections of the light guide. The cavity offers the advantage that heat of the light guide and/or the transparent display and/or the flat layer can be removed particularly effectively and overheating and thus a failure of the display device can be particularly effectively avoided. Additionally or alternatively thereto, the vehicle interior can appear larger due to the cavity, in particular when the display is switched off, since not the display itself, but a surface arranged behind the cavity and/or the light guide, delimits the vehicle interior, in particular apparently.

The planar light guide is configured to emit light from at least one light source via an exit surface in the direction of the transparent display, wherein the planar light guide comprises at least one connection for at least one light source, wherein the at least one connection is attached to the circumference of the planar light guide. This means that the at least one connection for introducing light into the planar light guide is arranged on at least one lateral surface of the light guide. The lateral surface of the planar light guide is in particular a surface that is different from the exit surface. In addition, the lateral surface can be different from a rear surface which is opposite to the exit surface and/or has an orientation counter to the exit surface. In particular, the lateral surface has a lower surface area than the exit surface and/or is perpendicular to the exit surface. The light guide is thus designed to transmit light of at least one light source, which is introduced in particular laterally on the light guide and/or on the at least one lateral surface of the light guide, within the light guide and emit it via an exit surface. Within the light guide it can be provided that the light is reflected at least once, for example on an inner side of a surface of the light guide, for example on the inner side of the rear surface and/or exit surface of the light guide. The light can be decoupled from the light guide via a microstructure on the surface of the light guide. Alternatively, it can be provided that the light propagates through the light guide parallel to the exit surface, in particular until it hits at least one scattering center by which the light is scattered out of the light guide. In particular, the light passes through the light guide in a direction different than the direction in which the light guide has its smallest extension. The light guide is arranged in particular in such a way that it is arranged at least partially parallel to the display and/or at least in one point of the light guide the direction of its smallest extension is the same as the direction of the smallest extension of the display. In particular, the shape of the light guide can follow the shape of the display.

The light guide is in particular configured to send light from a side facing away from the display area and/or the at least one occupant of the motor vehicle through the display having the switchable layer. A backlight of the display can result in this way. The backlight can result in the advantage that the transmittance of the transparent display having the switchable layer appears greater, so that the at least one occupant can in particular perceive an interior area arranged behind the transparent display and the switchable layer, which can be located behind the transparent light guide, better and/or brighter. This results in particular from the fact that more light penetrates through the light guide through the display having the switchable layer when the backlight is active than when the backlight is inactive, due to which a background behind the transparent display having the switchable layer can be better perceived. The effect is similar to the effect of sunglasses, in which a transparency of the lenses of the sunglasses appears greater in sunlight than without sunlight. The backlight is particularly useful, since the transparent display having the switchable layer has a lower transmittance than the transparent display.

The arrangement of the at least one connection on the circumference of the light guide allows, in particular in a transparent light guide, seeing through the display to an interior surface, which is arranged behind the light guide. This is in particular because one does not look directly into the at least one light source when reading the display device. It is possible for the vehicle interior to appear larger, since it is possible to see through the display, in particular especially well, in particular when the display is not being used and/or the display is inactive.

Seeing through the display results particularly well when light of at least one light source is conducted through the light guide and/or the switchable layer has the highest possible transmittance.

The invention also comprises refinements which result in additional advantages.

One refinement comprises that the cavity is open on at least one side and/or along at least one edge, in particular on all except for one side and/or edge, of the display. A side and/or edge of the display can be given by a border of the display area. For example, a shape of the display can be based on a rectangle. A cross section of the cavity can have the same and/or a similar shape as the display in a plane in which the display area of the display is located. In a plane perpendicular to the plane in which the display area of the display is located, it can be provided that the cavity is not structurally separated from the rest of the vehicle interior, in particular from the air in the rest of the vehicle interior. In general, the cavity open on at least one side and/or along at least one edge can mean that the cavity is not structurally separated from the rest of the vehicle interior on the at least one side and/or along the at least one edge.

The open cavity allows air to be exchanged between the cavity and the rest of the vehicle interior. This allows heat from the display and/or the light guide to be dissipated particularly effectively, providing protection against overheating to the display and/or the light guide. Additionally or alternatively, the cavity can be used as a storage option, for example for a mobile terminal, in particular a smartphone, and/or a note and/or a block and/or a purse.

One refinement comprises that the light guide is transparent. In particular, the light guide is penetrable from all sides for light. In particular, the light guide is transparent in the direction in which the light guide has its smallest extension and/or in which the transparent display has its smallest extension in each case. The fact that the light guide is transparent means in particular that the light guide lets through at least 70%, in particular at least 80%, preferably at least 90% of the incident light. From the transparency of the light guide, the advantage results that a background, for example an interior surface, on which the light guide is attached, is visible through the transparent display having the switchable layer and through the light guide, due to which, for example, the vehicle interior can appear larger and/or information and/or images can be displayed behind the display device and/or a seamless transition can be produced between the display device and an interior of the motor vehicle in which the display device is attached.

One refinement comprises that the switchable layer is divided into multiple regions controllable independently of one another, in particular strip-shaped regions. In particular, this means that the transmittance of the display having the switchable layer can be adjusted independently of one another in the regions. In this way, regions of the display can have a higher transmittance than other regions of the display. In this way, the display device can have regions on the display area in which one can see through the display device and regions in which seeing through is not made possible and/or in which black and/or dark pixels can be generated. In particular, this means that regions having different transmittance can be provided.

The strip shape is particularly advantageous because in this way a device for controlling the regions controllable independently of one another can be provided only on one side of the display, which is in particular perpendicular to the direction of the strips. In particular, the device for controlling is a device by means of which voltage can be applied to the controllable layer, and the controllable layer is a layer the transmittance of which changes when a voltage is applied and remains the same when a voltage is not applied.

One refinement comprises that the at least one planar light guide has multiple light guide layers, which each comprise at least one separate connection for at least one separate light source. This means in particular that, in the direction in which the light guide has its smallest extension and/or in the direction in which the display having the switchable layer is located from the light guide, multiple light guide layers are arranged one above the other and/or next to one another, wherein each light guide layer can be transparent in the direction of its smallest extension. Each light guide layer has at least one separate connection, so that each light guide layer is configured to have light introduced from at least one separate light source. This allows the light emitted from the respective light layer in the direction of the display to be individually adjusted in each case. In particular, it can be provided by the construction of the light guide from several light guide layers that the amounts of light emitted from the respective light guide layers in the direction of the display add up.

In particular if the different light guide layers have different brightness distributions, with which they emit light in the direction of the display, an individual adjustment of the brightness distribution via the display can take place due to the individual and/or separate controllability of the light guide layers, which can be implemented by the separate connections of the individual light guide layers, in particular when the display is not active and/or with the greatest possible transmittance of the display having the switchable layer, thus in particular the greatest possible transmittance of the switchable layer. Additionally or alternatively, it is possible to have each light guide layer light up in a different color by a corresponding selection of the light source, by which in particular a color selection for a backlight of the display can be provided cost-effectively.

With light guide layers arranged next to one another, it can advantageously be implemented that different regions of the display experience different levels of backlighting. Backlighting refers in particular to background lighting, i.e. lighting that is incident from behind on an object, such as the display. In particular, it is a very simple and/or cost-effective way to implement the different backlight levels for different regions of the display.

One refinement comprises that the planar light guide comprises multiple light guide layers. Of the multiple light guide layers, at least one diffuser layer is configured to emit the light of the at least one light source uniformly distributed over the entire exit surface. This means in particular that the diffuser layer has a constant brightness distribution over its entire exit surface. The diffuser layer can be designed, for example, as a volume diffuser, which is known from the prior art. A volume diffuser is a transparent component in which scattering centers are embedded. This means that in the volume of the volume diffuser there are scattering centers where the light is scattered, which is inside the volume diffuser and/or which meets one of the scattering centers in the volume diffuser. The scattering centers can be, for example, air inclusions. The diffuser layer is designed in particular as a volume diffuser, in which the scattering centers are uniformly distributed within the diffuser layer. A uniform distribution of the scattering centers in the diffuser layer can mean that the number of scattering centers differs from each other by at most 10%, in particular at most 5%, when considering any two equally large volume elements and/or that the distance between two adjacent scattering centers differs by at most 5% from the average distance between two scattering centers in the diffuser layer. Additionally or alternatively, the diffuser layer can have a microstructure, in particular a uniform microstructure, distributed over its entire exit surface, for uniformly decoupling the light out of the light guide. Due to the microstructure, the reflection coefficient on the surface of the light guide can be reduced. The advantage of the diffuser layer is a uniform backlight of the display.

In addition, of the multiple light guide layers at least one molded layer has scattering centers in a predeterminable partial region of the molded layer, so that the molded layer is configured to emit the light of the at least one light source only in the at least one predeterminable partial region, in particular via the exit surface. In particular, light is emitted in an emission region of the exit surface, which is an image and/or projection of the predeterminable partial region on the exit surface, in particular in the direction in which the light guide has its smallest extension and/or in the preferred direction. This means that the scattering centers are arranged only in the at least one predeterminable partial region or in greater concentration in the at least one predeterminable partial region than in the remaining light guide, so that, for example, at least 70%, in particular at least 80%, preferably at least 90% of the emitted light is scattered in the at least one predeterminable partial region and/or is emitted via the emission region. Additionally or alternatively, it can be provided that the microstructure is only within the emission region.

Additionally or alternatively thereto, the at least one molded layer in the predeterminable emission region of the exit surface can have a microstructure, so that the molded layer is designed to emit the light of at least one light source only in the predeterminable emission region. This means that the light is guided by means of total reflection on at least one inner surface of the molded layer within the molded layer. The inner surface is an inner side of a surface of the light guide. If the light in an area hits an inner side of the exit surface, which has no microstructure, a smaller amount of the light is decoupled from the light guide than if the light in the predeterminable emission region hits the inner side of the exit surface. In particular, at least 80%, preferably at least 90%, of the light propagating within the light guide is totally reflected, which hits in a region on the inner side of the exit surface, which has no microstructure. In particular, in the regions in which the exit surface has a microstructure, more light is decoupled from the light guide than in the regions without a microstructure.

The molded layer provides the advantage that the light is emitted in the form of a fixed symbol and/or fixed information and/or the display is backlit using light of the form of the fixed symbol and/or the fixed information. This allows information to be transmitted via the backlight of the display, for example.

The advantage of the combination of the at least one diffuser layer and the at least one molded layer is that optionally a uniform backlight of the display can be produced, so that the display can appear uniformly transparent, and/or a transparent appearing form, which corresponds to a form of the at least one predeterminable partial region, can be displayed on the otherwise less transparent appearing display. For example, the transparent appearing form can be used to transmit information.

As a further solution, the invention, according to an aspect of the present invention, comprises a motor vehicle comprising at least one motor vehicle display device, wherein a rear surface of the planar light guide opposite to the exit surface is attached on a, in particular opaque, interior surface in a vehicle interior of the motor vehicle. This means that the vehicle interior has at least one interior surface, for example, a part of a dashboard of the motor vehicle, on which the rear surface of the planar light guide is applied. The rear surface of the light guide is in particular the surface which has a reverse orientation to the exit surface of the light guide and/or which faces away from the display. This results in the advantage that when looking through the transparent display having the switchable layer and through the light guide, the interior surface is visible, due to which in particular a seamless transition between the vehicle interior and the display device exists.

One refinement of the motor vehicle comprises that the display is fastened only along one side and/or one edge and that the rest of the display is free-floating. In particular, this means that the display is only fastened along one side of the display and the rest of the display stands and/or hangs freely in the vehicle interior. The cavity open on at least one side and/or edge of the display can result in this way. A particularly efficient heat dissipation of at least one component of the display device, for example, of the display and/or the light guide and/or the switchable layer can take place through the free-floating part of the display. Additionally or alternatively thereto, additional storage space can result between the transparent display having the switchable layer and the light guide. In this storage space, for example, a mobile terminal, in particular a smartphone and/or a smartwatch, and/or a note sheet and/or a notepad can be accommodated.

One refinement of the motor vehicle comprises that the display having the switchable layer has a smaller extension in a vehicle vertical direction than the planar light guide. In particular, it can be provided that a side and/or edge of the display and the light guide located farther down in the vehicle vertical direction are arranged at the same height and/or at the same value in the vehicle vertical direction. In particular, it can be provided that only a part of the display located below in the vehicle vertical direction is backlit by the light guide and a part of the display located farther up in the vehicle vertical direction is not backlit by the light guide.

The display having the switchable layer is arranged in the vehicle in such a way that in a partial region of the display on the side of the switchable layer, only the switchable layer and, spaced apart therefrom, a vehicle window is located, which separates the vehicle interior from a vehicle exterior. This partial region of the display is preferably arranged farther up in the vehicle vertical direction than another region of the display, which can be backlit by the light guide. The partial region is characterized in particular in that in the partial region on the side of the switchable layer no light guide is arranged, so there is no backlight of the partial region. It can be provided that instead of the light guide, a vehicle window is arranged, the distance of which to the display can be lesser or greater than the distance between the display and the light guide in the other, backlit area of the display.

This refinement results in the advantage that in the partial region the vehicle exterior and/or at least a part of the vehicle exterior can be visible through the display, the switchable layer, and the vehicle window, in particular when the switchable layer has a state, in which it has the highest possible transparency and/or when the switchable layer transmits at least 30%, in particular at least 50% of the incident light. In this way, an effect similar to a head-up display known from the prior art can be achieved, in particular with the difference that in the other backlit region of the display, the interior surface is visible instead of a vehicle exterior, thus instead of the vehicle surroundings.

The vehicle window is preferably a windshield and/or front window and/or a side window of the motor vehicle. The vehicle exterior is at least a part of the surroundings of the motor vehicle.

One refinement of the motor vehicle comprises that the interior surface of the motor vehicle comprises at least one display which is configured to display, when the display is switched off, the same information that is displayed on the display when the display is used, in particular permanently. This means that information, which is displayed permanently on the display in particular when the display is active, is reproduced by a display in and/or on the interior surface at least with a deactivated and/or inactive display. The advantage is that the information is continuously available and/or can be read. The display can be a clock, for example. For example, the information can be information about current weather, a time specification, a date specification, and/or a specification about a quality of a connection to an external device and/or an external station.

One refinement of the motor vehicle comprises that a control device of the motor vehicle is configured to reproduce a first display on the display and to project a second display on the interior surface of the motor vehicle via at least one projector, wherein a total visible display is an overlay of the second display with the first display. This means that the total visible display reproduced by the display device is composed of the first display, which is carried out by means of the display, and of the second display, which is projected by means of the projector on the interior surface. This can create a three-dimensional effect on the visible display.

In order that the second display has a correct position relative to the first display, so that the first display and the second display correctly interact together from the view of the at least one occupant and/or appear relative to each other in the correct position, it can be provided that a position of the head of the at least one occupant is determined by means of at least one interior camera. Additionally or alternatively, if the occupant is the driver of the motor vehicle, a display adjustable by the driver, such as a head-up display, can be used to determine the head position of the driver.

The visible display composed of a first display and a second display can be used, for example, when information is to be displayed against a background with other information, for example when navigating the current location in front of a map.

The invention, according to an aspect of the present invention, also includes refinements of the motor vehicle according to the invention, which have features as have already been described in connection with the refinements of the motor vehicle display device according to the invention. For this reason, the corresponding refinements of the motor vehicle according to the invention will not be described again here.

As a further solution, the invention, according to an aspect of the present invention, furthermore comprises a method for operating the motor vehicle display device using at least one light source and/or a method for operating a vehicle having a motor vehicle display device and preferably at least one light source. The method comprises that an output is displayed on the display area of the transparent display, for which purpose the switchable layer is attached to the surface of the transparent display opposite to the display area, by which a darkening of at least parts of the display area is achieved at a set first transmittance. At a set second transmittance of the switchable layer, which is greater than the first transmittance, by emitting light via a planar light guide arranged on the side of the switchable layer from the display and attached spaced apart from the switchable layer, a transmittance of light through the motor vehicle display device and/or the display having the switchable layer and/or an apparent transparency of the motor vehicle display device and/or the display having the switchable layer is increased. This means that the transmittance of the switchable layer can be changed and/or adjusted, wherein different effects can be achieved depending on the set transmittance. At the first transmittance, in which a lower percentage of the light incident on the switchable layer is transmitted through the switchable layer, a darker area can be provided than at the second transmittance, which is located behind the transparent display. In particular, this results in the option of creating and/or displaying darker pixels. At the second transmittance, in contrast, an apparent transparency of the display and/or the display device can be achieved, i.e. an interior surface behind the display device and/or a surface behind the transparent display having the switchable layer can be better seen and/or perceived in more details.

One refinement of the method comprises that light from a light source is emitted via the planar light guide and/or at least one region of the switchable layer has the second transmittance, if nothing is displayed on the display and/or something is displayed on only part of the display and/or at least part of the display displays something that does not require a dark and/or black background to be displayed. In this way, an apparent transparency of the display can be achieved at least in the cases and/or regions in which a background, in particular the interior surface and/or a part of the vehicle exterior, is to be visible and/or a dark and/or black background does not have to be provided to display information with dark and/or black pixels.

For application cases or application situations which can arise in the method and which are not explicitly described here, provision can be made for an error message and/or a request for input of a user acknowledgement to be issued according to the method and/or for a default setting and/or a predetermined initial state to be set.

The invention also includes refinements of the method according to the invention which have features as have already been described in conjunction with the refinements of the motor vehicle according to the invention and/or the motor vehicle display device according to the invention. For this reason, the corresponding refinements of the method according to the invention are not described here again.

As a further solution, the invention, according to an aspect of the present invention, also comprises a computer-readable storage medium comprising program code which, when executed by a computer or a computer network, causes it to carry out one embodiment of the method according to the invention. The storage medium can at least partially be provided as a non-volatile data memory (e.g. as a flash memory and/or as an SSD – solid state drive) and/or at least partially as a volatile data memory (e.g. as a RAM – random access memory). The storage medium can be arranged in the computer or computer network. The storage medium can, however, also be operated, for example, as a so-called app store server and/or cloud server on the Internet. A processor circuit having, for example, at least one microprocessor can be provided by the computer or computer network. The program code can be provided as binary code and/or as assembler code and/or as source code of a programming language (e.g. C) and/or as a program script (e.g. Python). The computer-readable storage medium can alternatively be implemented by a signal having computer-readable data, for example a time-varying voltage signal and/or a radio signal.

The invention, according to an aspect of the present invention, also includes the control device for the motor vehicle display device. The control device can comprise a data processing device or a processor unit (processor circuit) which is configured to carry out one embodiment of the method according to the invention. The processor unit can have at least one microprocessor and/or at least one microcontroller and/or at least one FPGA (Field Programmable Gate Array) and/or at least one DSP (Digital Signal Processor) for this purpose. In particular, a CPU (Central Processing Unit), a GPU (Graphical Processing Unit), or an NPU (Neural Processing Unit) can each be used as a microprocessor. Furthermore, the processor unit can have program code which is configured to carry out the embodiment of the method according to the invention when executed by the processor device. The program code can be stored in a data memory of the processor unit. The processor unit can be based, for example, on at least one circuit board and/or on at least one SoC (System on Chip).

The invention also comprises the combinations of the features of the embodiments described. The invention thus also comprises implementations that each have a combination of the features of several of the embodiments described, unless the embodiments have been described as mutually exclusive.

### BRIEF DESCRIPTION OF THE DRAWINGS

These and other aspects and advantages will become more apparent and more readily appreciated from the following description of the exemplary embodiments, taken in conjunction with the accompanying drawings of which:

Exemplary embodiments of the invention are described below. In the figures:

FIG. 1 shows a schematic cross section of an embodiment of a motor vehicle display device according to the invention;

FIG. 2 shows a schematic cross section of an embodiment of a motor vehicle display device according to the invention;

FIG. 3 shows a schematic representation of an embodiment of a motor vehicle display device according to the invention.

### DETAILED DESCRIPTION

Reference will now be made in detail to the preferred embodiments, examples of which are illustrated in the accompanying drawings, wherein like reference numerals refer to like elements throughout.

The exemplary embodiments explained below are preferred embodiments of the invention. In the exemplary embodiments, the described components of the embodiments are each individual features of the invention that are intended to be considered independently of one another and that each also refine the invention independently of one another. Therefore, the disclosure is intended to also comprise combinations of the features of the embodiments other than those described. Furthermore, the embodiments described can also be supplemented by other instances of the features of the invention that have already been described.

In the figures, identical reference signs denote functionally identical elements in each case.

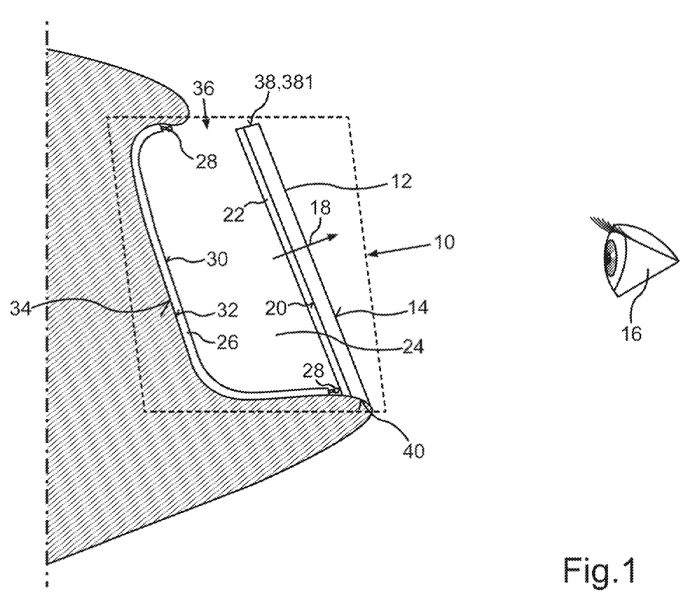

FIG. 1 shows, for example, an embodiment of the motor vehicle display device 10. The motor vehicle display device 10, hereinafter also referred to as display device 10, comprises a transparent display 12, also called display 12, which comprises a display area 14. The display area 14 can be that surface of the display 12 which faces toward an occupant 16 of a vehicle, represented by the eye, in a display device 10 integrated in a vehicle. In particular, the display area 14 is a surface perpendicular to a preferred direction 18, wherein the preferred direction 18 is the direction in which the display 12 has the smallest extension. On the display area 14, contents and/or information can be displayed, which can be registered, for example, by at least one occupant 16.

On a surface opposite to the display area 14, for example on a rear side 20 of the display 12 to the display area 14, a switchable layer 22 is attached, the transmittance of which is changeable and/or adjustable. This means that it can be adjusted how much of the light incident on the switchable layer 22 is transmitted through the switchable layer 22 and forwarded into the display 12. In order to change its transmittance, the switchable layer 22 can, for example, have a control device, which applies a predeterminable voltage for a predeterminable period of time upon receiving a predeterminable signal.

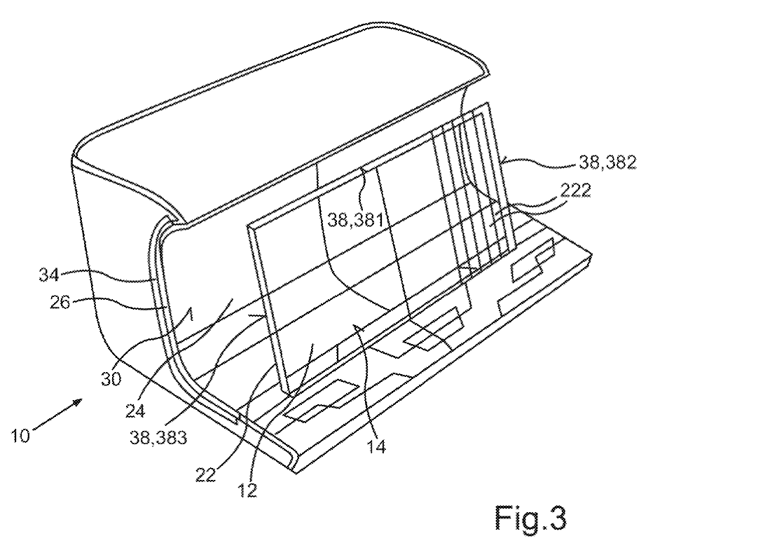

The switchable layer 22 can be divided, as schematically shown by way of example in FIG. 3, into multiple regions 222 controllable independently of one another, which can be adjusted independently of one another. In this way, different transmittances can be assigned to various regions of the display 12 having the switchable layer 22, which correspond to the regions 222 of the switchable layer 22 controllable independently of one another.

A light guide 26 is arranged spaced apart by a cavity 24 on the side of the display 12 on which the switchable layer 22 is attached. The light guide 26 comprises at least one connection 28 (in the present example, two connections are shown as an example), which is configured to be connected to at least one light source. Light from at least one light source can be introduced into the light guide 26 via the at least one connection 28.

The light guide 26 can be designed as a volume diffuser, that is, have multiple scattering centers within a transparent volume at which the light propagating within the volume can be scattered. Due to the scattering of light at the scattering centers, a direction of propagation of the light can change, so that the light exits from the light guide 26.

The light guide 26 can be designed such that the scattering centers are distributed within the entire light guide 26, in particular uniformly, so that a uniform emission of the light results. This means in particular that the amount of light emerging per unit of time from the light guide 26 at each point of an exit surface 30, which corresponds to a surface of the light guide 26 facing toward the display 12, is equal, preferably within the scope of a predeterminable error interval. Uniform backlighting of the display 12 thus takes place.

Additionally or alternatively, it can be provided that scattering centers are present only in a predeterminable partial region of the light guide 26 and/or the number of scattering centers in the predeterminable partial region is greater than in the remaining light guide 26. This means that in the predeterminable partial region propagating light is scattered more in the light guide 26, due to which more light exits from the light guide 26 within a predeterminable emission region than on the remaining exit surface 30. The predeterminable emission region can be a projection of the predeterminable partial region on the exit surface 30.

The effect that more light exits from the light guide 26 within a predeterminable emission region than on the remaining exit surface 30 can be achieved additionally or alternatively thereto by means of a microstructure which is present in the predeterminable emission regions on the exit surface 30 of the light guide 26. The microstructure is configured to increase the probability of light emerging from the light guide 26.

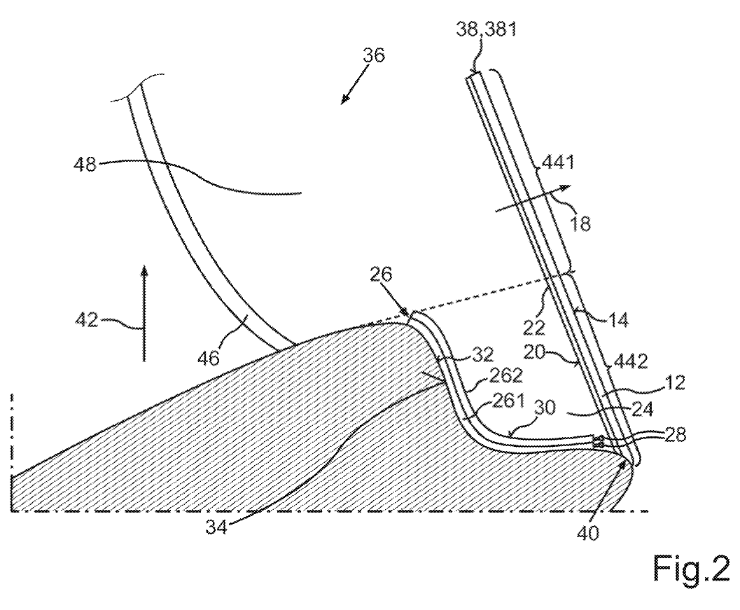

The light guide 26 can, as illustrated by way of example in FIG. 2, comprise multiple light guide layers 261, 262, of which at least one of the light guide layers 261 emits light from the light guide layer 161 uniformly distributed over the exit surface 30. This at least one light guide layer 161 can be referred to as a diffuser layer. Additionally or alternatively, at least another of the light guide layers 162, which can be referred to as a molded layer, emits over a predeterminable emission region a greater amount of light per unit of area than over the remaining exit surface 30.

Each of the light guide layers 261, 262 can, for example, for separate control, have at least one separate connection 28 for connecting the at least one light source.

Alternatively to the multiple light guide layers 261, 262, the light guide 26 can comprise only one light guide layer 261, 262, as shown by way of example in FIG. 1.

The at least one connection 28 for connecting the at least one light source is arranged on the circumference of the light guide 26. This means in particular that the at least one connection 28 is attached in each case on a side of the light guide 26 and/or the light guide layer 261, 262, which is different from the exit surface 30 of the light guide 26 and a rear surface 32 of the light guide 26 opposite to the exit surface 30.

In particular, it can be provided that the light source is not attached to the rear surface 32 of the light guide 26, so that in a light guide 26, which is transparent, in particular in the preferred direction 18, through the light guide 26, in particular through the display 12, the switchable layer 22, and the light guide 26, an interior surface 34 can be seen, for example, by the occupant 16 of the vehicle. The interior surface 34 can be a surface, in particular in a vehicle interior, on which the light guide 26 is attached.

The cavity 24 is located between the light guide 26 and the display 12 having the switchable layer 22. The cavity 24 can have at least one opening 36, so that in particular an air exchange of air in the cavity 24 with air outside the cavity 24 can take place. In order that the cavity 24 has the opening 36, the cavity 24 can be open along at least one edge and/or side 38, 381, 382, 383 of the display 12.

As an example, for the opening 36 of the cavity 24 it is shown in FIG. 1 and FIG. 2 that the cavity 24 is open at least along the upper edge and/or side 38, 381 of the display 12. In FIG. 3, the cavity is additionally open at least along the lateral edges and/or sides 38, 382, 383 of the display 12.

The opening 36 of the cavity 24 can be implemented by the display 12 along the at least one edge and/or side 38, 381, 382, 383 being structurally separated from other elements and/or components, in particular all other elements and/or components, of the vehicle interior, in which the display device 10 is attached and/or which the display device 10 comprises. In particular, it can be provided that the display 12 is only fastened along one side and/or edge 40 and the rest of the display 12 is free-standing, as shown in the figures, in particular in FIG. 3 (since FIG. 1 and FIG. 2 are each a cross section through the display device 10).

As shown by way of example in FIG. 2, it can be provided that in a motor vehicle comprising the at least one display device 10, an extension of the light guide 26 in the vehicle vertical direction 42 is less than an extension of the display 12 having the switchable layer 22 in the vehicle vertical direction 42. In this way, the display 12 can be divided into two areas 441, 442 (FIG. 2 shows an example of a division into the upper region 441 and the lower region 442): once into an upper region 441, which is, for example, located in FIG. 2 in the vehicle vertical direction above the lower region 442 and in which there is no backlight, and into a lower region 442, which is, for example, located in FIG. 2 in the vehicle vertical direction below the upper region 441 and in which there is a backlight. In particular, the lower region 442 is adjacent to a lower display end provided by a lower side and/or edge 40 and/or the upper region 441 is adjacent to an upper display end provided by an upper side and/or edge 38, 381 of the display 12.

The lower region 442 can be characterized in that, in the preferred direction, on the side of the display 12 on which the switchable layer 22 is located, the light guide 26 is arranged over the entire lower region 442. This means that starting from each point of the display 12 within the lower region 442, a straight line which extends parallel to the preferred direction 18 intersects the light guide 26 after the cavity 24. This means that the lower region 442 can be backlit.

The upper region 441 is characterized in that on the side of the switchable layer 22 of the display 12, spaced apart from the switchable layer, only one vehicle window 46 is arranged, thus no light guide 26 is located. This means that starting from each point of the display 12 within the lower region 442, a straight line which extends parallel to the preferred direction 18 intersects the switchable layer 22 on the side of the switchable layer 22 from the display 12 and then the vehicle window 46. Between the switchable layer 22 and the vehicle window 46, there can be a gap 48. Thus, when observing the upper region 441 of the display 12 from the preferred direction 18, in particular with sufficient transmittance of the display 12 and the switchable layer 22, it is possible to see through the vehicle window 46.

It can be provided that additionally or alternatively to a display of information on the display 12, identical and/or supplementary and/or additional information is displayed on the interior surface 34. For this purpose, the display device 10 can comprise at least one projector, which projects identical and/or supplementary and/or additional information on the interior surface 34. Additionally or alternatively thereto, it can be provided that the interior surface 34 comprises at least one display on which, when the display 12 is deactivated, information is displayed which is permanently displayed on the display 12, so that this information can be available independently of the state of the display 12.

A particularly preferred exemplary embodiment is described hereinafter:

From the prior art, a light guide in the form of a transparent film is known, which is designed to be used as a backlight for displays. The light guide can have a thickness of at most 2 mm, in particular at most 1 mm. Within the light guide, the light can be forwarded via total reflection, wherein the light is fed into the light guide via at least one connection, in particular at an edge of the light guide. Light can be deliberately decoupled from the light guide by a microstructure on a surface and/or exit surface of the light guide.

It can be provided that the deliberate decoupling of the light from the light guide only takes place in predeterminable emission regions, which is a partial region of the exit surface of the light guide. In this way, at least one illuminated symbol and/or at least one illuminated graphic and/or at least one illuminated structure can be displayed.

In the switched-off state, the light guide can be transparent, i.e. transmit in particular at least 80%, preferably 90%, of the incident light. The at least one illuminated symbol and/or the at least one illuminated graphic and/or the at least one illuminated structure may not be visible in the state in which no light is transmitted through the light guide.

The light guide can be attached and/or laminated on an interior surface (application) arranged behind a transparent display. A distance is formed between the light guide and the transparent display, in particular by a cavity. The distance can be between 5 cm and 30 cm.

Transparent displays, as they are known from the prior art, are not completely transparent, in particular when a switchable layer is attached, by which a transmittance of the display having the switchable layer can be adjustable. The switchable layer can be a PDLC layer, as is known from the prior art. The switchable layer can be adjustable between opaque and partially transparent. The switchable layer can be necessary to create a black background because transparent displays cannot produce high contrast.

The light guide can comprise multiple light guide layers, for example a light guide layer for planar illumination and/or backlighting of the display and/or a light guide layer for displaying at least one symbol and/or at least one graphic and/or at least one structure.

The interior surface can be illuminated by the light guide attached behind the display, so that it is visible through the transparent display having the switchable layer.

The advantage of the display device is an illumination of the display which is extensive and/or homogeneous and/or subtle and/or enhances an impression of the transparency of the display. Additionally or alternatively thereto, the interior surface is more visible, which makes the display better integrated into the interior and/or vehicle interior. Additionally or alternatively thereto, the display does not look like a foreign object. Additionally or alternatively thereto, a black surface is not seen when the display is switched off, as with other displays known from the prior art, but rather the interior surface behind the display. In this way, the vehicle interior and/or the interior can appear wider and lighter. Additionally or alternatively thereto, the light guide is translucent and/or transparent when switched off, due to which the material underneath, in particular the interior surface, is visible. Additionally or alternatively thereto, the illumination can alternately be switched on and off.

Overall, the examples show how a luminous film and/or a light guide can be provided on an application and/or interior surface behind a transparent display in order to enhance the impression of transparency of the display.

A description has been provided with particular reference to preferred embodiments thereof and examples, but it will be understood that variations and modifications can be effected within the spirit and scope of the claims which may include the phrase "at least one of A, B and C" as an alternative expression that means one or more of A, B and C may be used, contrary to the holding in Superguide v. DIRECTV, 358 F3d 870, 69 USPQ2d 1865 (Fed. Cir. 2004).

What is claimed is:

1. A motor vehicle display device for an interior of a motor vehicle, comprising:
a flat transparent display having a display area, a switchable layer being attached to a surface of the flat transparent display opposite to the display area, transmittance of the switchable layer being changeable, and
a planar light guide arranged on a side of the switchable layer, spaced apart by a cavity from the switchable layer,
wherein the planar light guide is configured to emit light from at least one light source via an exit surface along a direction of the flat transparent display, and
wherein the planar light guide comprises at least one connection for the at least one light source and the at least one connection is attached to a circumference of the planar light guide.

2. The motor vehicle display device as claimed in claim 1, wherein
the cavity is open on at least one side and/or along at least one edge of the flat transparent display.

3. The motor vehicle display device as claimed in claim 1, wherein
the cavity is open on all except for one side and/or edge of the flat transparent display.

4. The motor vehicle display device as claimed in claim 1, wherein
the planar light guide is transparent.

5. The motor vehicle display device as claimed in claim 2, wherein
the planar light guide is transparent.

6. The motor vehicle display device as claimed in claim 1, wherein
the switchable layer is divided into multiple regions , which are strip-shaped regions, controllable independently of one another.

7. The motor vehicle display device as claimed in claim 1, wherein
the planar light guide has multiple light guide layers, each comprising at least one separate connection for at least one separate light source.

8. The motor vehicle display device as claimed in claim 7, wherein
of the multiple light guide layers, at least one diffuser layer is configured to emit the light from the at least one light source uniformly distributed through entirety of the exit surface , and
at least one molded layer has scattering centers in at least one predeterminable partial region of the at least one molded layer and/or has a microstructure in a predeterminable emission region of the exit surface, so that the at least one molded layer is configured to emit the light from the at least one light source only in the at least one predeterminable partial region and/or in the predeterminable emission region.

9. A motor vehicle comprising at least one motor vehicle display device as claimed in claim 1.

10. A motor vehicle display device for an interior of a motor vehicle, comprising:
a flat transparent display having a display area, a switchable layer being attached to a surface of the flat transparent display opposite to the display area, transmittance of the switchable layer being changeable, and
a planar light guide arranged on a side of the switchable layer, spaced apart by a cavity from the switchable layer,
wherein the planar light guide is configured to emit light from at least one light source via an exit surface along a direction of the flat transparent display, wherein the planar light guide comprises at least one connection for the at least one light source and the at least one connection is attached to a circumference of the planar light guide, and
wherein a rear side of the planar light guide opposite to the exit surface is attached on an opaque interior surface in the interior of the motor vehicle.

11. The motor vehicle display device as claimed in claim 10, wherein
the flat transparent display is only fastened along one side and/or one edge and a rest of the flat transparent display is free-floating.

12. The motor vehicle display device as claimed in claim 10, wherein
the flat transparent display having the switchable layer has a smaller extension along a vehicle vertical direction than the planar light guide, and
the flat transparent display having the switchable layer is arranged in the motor vehicle in such a way that, in a partial region of the flat transparent display on the side of the switchable layer, only the switchable layer and spaced apart therefrom a vehicle window, which separates the interior from a vehicle exterior, are located.

13. The motor vehicle display device as claimed in claim 10, wherein
the opaque interior surface of the motor vehicle comprises at least one display, which is configured to display same information, when the flat transparent display is switched off, that is displayed on the flat transparent display as while the flat transparent display is used.

14. The motor vehicle display device as claimed in claim 10, further comprising:
a control device configured to reproduce a first display on the flat transparent display and to project a second display on the opaque interior surface of the motor vehicle via at least one projector,
wherein a total visible display is a superposition of the second display with the first display.

15. A method for operating the motor vehicle display device as claimed in claim 1 using the at least one light source and/or for operating the motor vehicle having the motor vehicle display device,
wherein
an output is displayed on the display area of the flat transparent display, the switchable layer being attached to the surface of the flat transparent display opposite to the display area, by which,
at a first transmittance that is set, a darkening of at least parts of the display area is achieved, and
at a second transmittance of the switchable layer set to be greater than the first transmittance, by emitting light via the planar light guide arranged on the side of the switchable layer from the flat transparent display and attached spaced apart from the switchable layer, a transmittance of light through the motor vehicle display device and/or the flat transparent display having the switchable layer and/or an apparent transparency of the motor vehicle display device and/or the flat transparent display having the switchable layer is increased.

16. The method as claimed in claim 14, wherein
light from a light source is emitted via the planar light guide and/or at least one region of the switchable layer has the second transmittance when:
nothing is displayed on the flat transparent display, and/or
something is displayed on only part of the flat transparent display, and/or
something is displayed on at least part of the flat transparent display that does not require a dark and/or black background to display.
